(19) United States
(12) Patent Application Publication
(10) Pub. No.: US 2022/0121142 A1
(43) Pub. Date: Apr. 21, 2022

(54) IMAGE FORMING APPARATUS

(71) Applicant: KYOCERA Document Solutions Inc., Osaka (JP)

(72) Inventors: Takahito MORITA, Osaka (JP); Hiroyoshi OMURA, Osaka (JP)

(73) Assignee: KYOCERA Document Solutions Inc., Osaka (JP)

(21) Appl. No.: 17/422,402

(22) PCT Filed: Dec. 11, 2019
(86) PCT No.: PCT/JP2019/048486

§ 371 Date: Jul. 12, 2021

(30) Foreign Application Priority Data
Jan. 16, 2019 (JP) 2019-004934

(51) Int. Cl. G03G 15/20; G03G 15/00

(52) U.S. Cl. CPC G03G 15/2028; G03G 15/6552

(57) ABSTRACT

An image forming apparatus includes a fixing device, a discharge roller pair, a detection portion, and a discharge control unit. The discharge roller pair discharges a sheet on which a toner image has been fixed in the fixing device to a discharge tray via a discharge port. The detection portion detects a rear end of the sheet being conveyed from the fixing device toward the discharge port. The discharge control unit performs control so that, within a prescribed period from a point in time of detection of the rear end of the sheet by the detection portion to when the rear end of the sheet passes through the discharge roller pair, a discharge speed of the sheet is reduced to a value lower than a reference speed, and after a lapse of the prescribed period, the discharge speed is increased back to the reference speed.

### TECHNICAL FIELD

The present invention relates to an image forming apparatus using an electrophotographic method, such as a copy machine, a printer, a facsimile, or a multi-functional peripheral having functions of these apparatuses.

### BACKGROUND ART

In such an image forming apparatus using the electrophotographic method, toner is applied to an electrostatic latent image formed on an image carrier such as a photosensitive drum so that a toner image is formed thereon. Further, the toner image thus formed is transferred to a sheet such as a paper sheet, and then the toner image on the sheet is fixed by a fixing device.

Meanwhile, a sheet immediately after being subjected to fixing is in a heated state at a considerably high temperature. When the sheet after being subjected to fixing is discharged, without being sufficiently cooled, to a discharge tray and stacked thereon, re-fusion of toner might occur, causing stacked sheets to stick to each other. To address this issue, there have conventionally been proposed configurations for cooling a sheet that has been subjected to fixing.

For example, Patent Document 1 discloses an apparatus including a sheet cooling unit that has a cooling area for cooling a sheet discharged from a fixing device and a control unit that variably controls a conveyance speed of the above-described sheet. The above-described control unit performs control so that, based on information used at the time of image formation, such as a printing mode or an image density, the conveyance speed of the sheet being conveyed through the cooling area is varied. For example, when the conveyance speed of the sheet is set to be reduced, it takes an increased amount of time for the sheet to pass through the cooling area, thus making it possible to enhance an effect of cooling the sheet.

### LIST OF CITATIONS

### Patent Literature

Patent Document 1: JP-A-2007-155855

### SUMMARY OF INVENTION

### Technical Problem

Meanwhile, when the conveyance speed of the sheet is set to be reduced, while the effect of cooling the sheet is enhanced, in a case of continuous printing, the number of sheets printed per prescribed amount of time is decreased to decrease sheet productivity. Conversely, when the conveyance speed of the sheet is set to be increased, while a decrease in the sheet productivity can be avoided, the effect of cooling the sheet is degraded, so that there might occur sticking between sheets on a discharge tray. Furthermore, when conveyed at an increased speed, the sheet is discharged vigorously to the discharge tray to be stacked thereon in a disorganized manner, so that an alignment property (stacking property) of the sheets is impaired.

It is, therefore, desired to suppress sticking between sheets discharged on a discharge tray, while taking into account sheet productivity in the case of continuous printing and an alignment property of the sheets stacked on the discharge tray. Patent Document 1, however, makes no consideration of this point.

### Solution to Problem

An image forming apparatus according to one aspect of the present invention includes a fixing device that fixes a toner image on a sheet, a discharge roller pair that discharges the sheet on which the toner image has been fixed in the fixing device to a discharge tray via a discharge port, a detection portion that detects a rear end of the sheet being conveyed from the fixing device toward the discharge port, and a discharge control unit that, based on an amount of time that has elapsed from a point in time of detection of the rear end of the sheet by the detection portion, controls rotation of a discharge roller included in the discharge roller pair so as to control a discharge speed of the sheet. The discharge control unit performs control so that, within a prescribed period from the point in time of detection of the rear end to when the rear end of the sheet passes through the discharge roller pair, the discharge speed of the sheet is reduced to a value lower than a reference speed, and after a lapse of the prescribed period, the discharge speed of the sheet is increased back to the reference speed.

### Advantageous Effects of Invention

According to the above-described configuration, it is possible, while maintaining sheet productivity, to obtain an effect of improving an alignment property of sheets on a discharge tray and an effect of suppressing sticking between the sheets.

### BRIEF DESCRIPTION OF DRAWINGS

FIG. 1 is a perspective view showing an external configuration of an image forming apparatus according to one embodiment of the present invention.

FIG. 2 is a sectional view schematically showing a diagrammatic configuration of the above-described image forming apparatus.

FIG. 3 is a sectional view schematically showing a detailed configuration of a sheet discharge portion of the above-described image forming apparatus.

FIG. 4 is a block diagram schematically showing a configuration of a control system that controls rotation of a discharge roller for discharging a sheet in the above-described image forming apparatus.

FIG. 5 is a flow chart showing a flow of processing under discharge control of the above-described sheet.

FIG. 6 is a graph showing variations in discharge speed of the above-described sheet under the above-described discharge control.

FIG. 7 is a sectional view schematically showing a state where a rear end of the above-described sheet has passed through a detection portion.

FIG. 8 is a sectional view schematically showing a state where the rear end of the above-described sheet has passed through a discharge roller pair.

FIG. 9 is a graph showing variations in discharge speed under another type of discharge control of the above-described sheet.

### DESCRIPTION OF EMBODIMENT

### [Diagrammatic Configuration of Image Forming Apparatus]

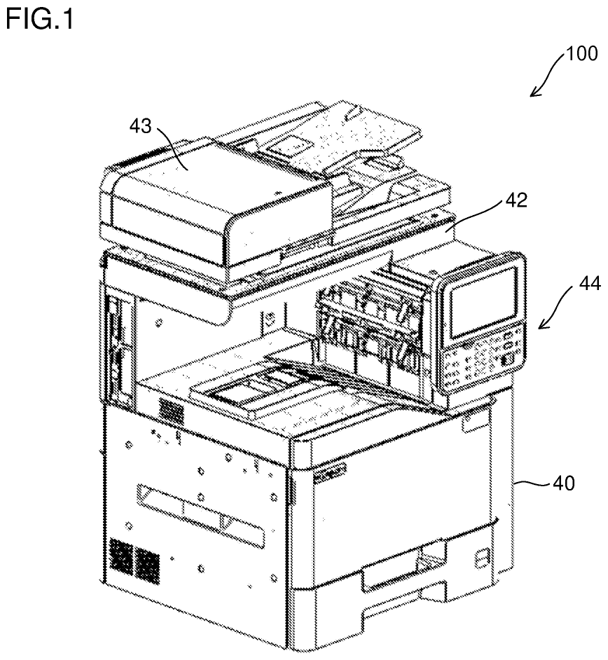

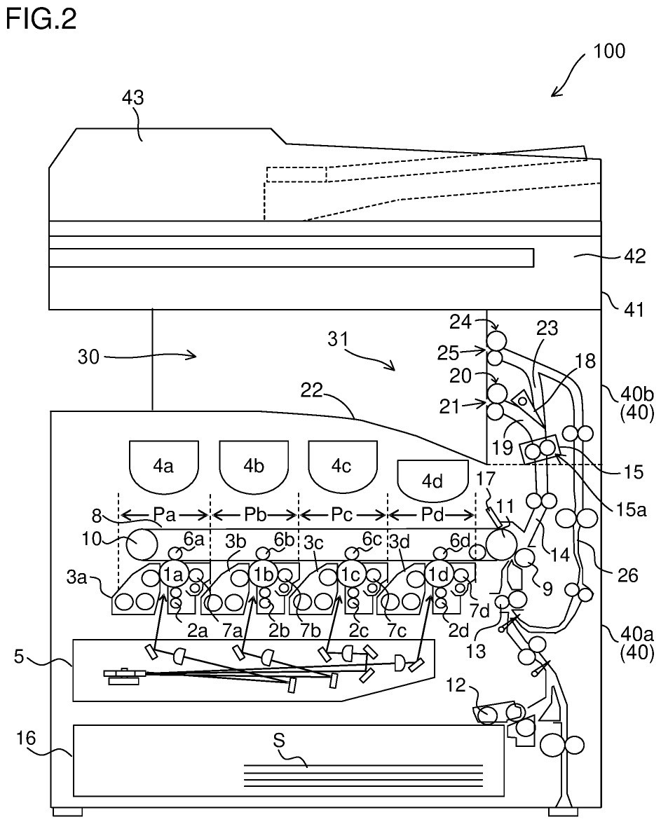

In view of the above-described problem, the present invention provides an image forming apparatus that is capable, while maintaining sheet productivity, of improving an alignment property of sheets on a discharge tray and suppressing sticking between the sheets. The following describes an embodiment of the present invention with reference to the appended drawings. FIG. 1 is a perspective view showing an external configuration of an image forming apparatus 100 according to one embodiment of the present invention, and FIG. 2 is a sectional view schematically showing a diagrammatic configuration of the image forming apparatus 100. The image forming apparatus 100 is, for example, a tandem color copy machine of an intra-body paper discharge type. The image forming apparatus 100 is composed generally of a main body housing 40 and an upper housing 41 disposed above the main body housing 40.

An image reading portion 42 is provided in the upper housing 41. The image reading portion 42 is composed of a scanner lamp, a scanning optical system, a condenser lens, a CCD sensor, and so on (none of these are shown). The image reading portion 42 reads an image on an original document and converts it into image data. The scanner lamp illuminates the original document during copying. The scanning optical system is equipped with a mirror for changing an optical path of reflection light from the original document. The condenser lens condenses the reflection light from the original document so as to form the reflection light into an image. The CCD sensor converts image light thus formed into an electric signal.

In a case where an original document is to be read one by one by the image reading portion 42, an original document conveyance device 43 situated above the image reading portion 42 is opened. Then, the original document is placed on a contact glass provided on an upper surface of the upper housing 41. Furthermore, in a case where a bundle of original documents is to be automatically read by the image reading portion 42, the bundle of original documents is placed on a paper feed tray of the original document conveyance device 43 in a closed state. With this configuration, an original document is automatically fed, from the bundle of original documents, one by one onto the contact glass.

The main body housing 40 is composed of a lower housing 40a and a connection housing 40b. The connection housing 40b is situated above the lower housing 40a along a right side part in FIG. 2 and is connected to the upper housing 41. In the connection housing 40b, there is provided an operation panel 44 (see FIG. 1) that accepts a user's input for setting the number of copies to be made or the like. The connection housing 40b also constitutes a sheet discharge portion 31 where a sheet S on which printing has been performed is discharged on a discharge tray 22 situated at a bottom part of an intra-body discharge space 30. A paper sheet for copying, a postcard, an envelope, a transparent film, or the like in general use can be used as the sheet S.

The lower housing 40a includes image forming portions Pa to Pd, an exposure device 5, a paper feed cassette 16, and so on arranged therein. In the lower housing 40a, the four image forming portions Pa, Pb, Pc, and Pd are disposed in this order (in order from the left side in FIG. 2) along a travel direction of an intermediate transfer belt 8. The intermediate transfer belt 8 is driven by a driver (not shown) to travel counterclockwise in FIG. 2. The image forming portions Pa to Pd are provided so as to correspond to images of four different colors (cyan, magenta, yellow, and black) and each perform steps of charging, exposure, development, and transfer so that they sequentially form images of cyan, magenta, yellow, and black, respectively.

The image forming portions Pa to Pd respectively include photosensitive drums 1a, 1b, 1c, and 1d that are disposed therein to carry visible images (toner images) of the respective colors. The above-described intermediate transfer belt 8 is further provided adjacently to the image forming portions Pa to Pd. Toner images formed respectively on the photosensitive drums 1a to 1d are sequentially and primarily transferred so as to be superimposed on each other on the intermediate transfer belt 8 traveling in contact with the photosensitive drums 1a to 1d, and then are secondarily transferred on the sheet S by the action of a secondary transfer roller 9. The sheet S on which the toner images have been secondarily transferred is discharged, for example, on the discharge tray 22 after the toner images have been fixed in a fixing device 15. While the photosensitive drums 1a to 1d are being caused to rotate in a clockwise direction in FIG. 2, an image forming process with respect to each of the photosensitive drums 1a to 1d is performed.

The sheet S on which a toner image is to be transferred is housed in the paper feed cassette 16 in a lower part of a main body of the image forming apparatus 100. The above-described sheet S is conveyed to a nip between the secondary transfer roller 9 and an after-mentioned drive roller 11 of the intermediate transfer belt 8 via a paper feed roller 12 and a registration roller pair 13. As the intermediate transfer belt 8, a non-seamed (seamless) belt made of a dielectric resin sheet is mainly used. Furthermore, a blade-shaped belt cleaner 17 for removing residual toner or the like remaining on a surface of the intermediate transfer belt 8 is arranged on a downstream side of the secondary transfer roller 9.

Next, a description is given of the image forming portions Pa to Pd. Chargers 2a, 2b, 2c, and 2d, the exposure device 5, developing devices 3a, 3b, 3c, and 3d, and cleaning portions 7a, 7b, 7c, and 7b are provided around and below the photosensitive drums 1a to 1d, which are disposed rotatably. The chargers 2a, 2b, 2c, and 2d charge the photosensitive drums 1a to 1d, respectively. Based on image data, the exposure device 5 exposes each of the photosensitive drums 1a to 1d to light. The developing devices 3a, 3b, 3c, and 3d each form a toner image on a corresponding one of the photosensitive drums 1a to 1d. The cleaning portions 7a, 7b, 7c, and 7d remove residual developer (toner) or the like remaining on the photosensitive drums 1a to 1d, respectively.

In a case of performing a copy operation, in the image reading portion 42, an image on an original document is read and converted into image data. Then, surfaces of the photosensitive drums 1a to 1d are uniformly charged by the chargers 2a to 2d, respectively. Subsequently, by the exposure device 5, irradiation with light is performed based on the above-described image data so that an electrostatic latent image based on the above-described image data is formed on each of the photosensitive drums 1a to 1d. The developing devices 3a to 3d are each filled with a prescribed quantity of developer (for example, two-component developer) containing toner of a corresponding one of the respective colors of cyan, magenta, yellow, and black. In a case where, as a result of forming a toner image, the percentage of toner contained in the developer filled in the developing devices 3a to 3d falls below a set value, fresh toner is replenished from toner containers 4a to 4d to the developing devices 3a to 3d, respectively. The toner contained in the developer is supplied onto the photosensitive drums 1a to 1d by the developing devices 3a to 3d, respectively, and electrostatically adheres thereto, and thus a toner image based on the above-described electrostatic latent image is formed.

Then, a prescribed transfer voltage is applied to primary transfer rollers 6a to 6d so as to cause the toner images of yellow, cyan, magenta, and black on the photosensitive drums 1a to 1d to be primarily transferred on the intermediate transfer belt 8. These images of the four different colors are formed in a prescribed positional relationship predetermined for prescribed full-color image formation. After that, in preparation for subsequent formation of new electrostatic latent images, residual toner or the like remaining on the surfaces of the photosensitive drums 1a to 1d is removed by the cleaning portions 7a to 7d, respectively.

The intermediate transfer belt 8 is stretched between a tension roller 10 on an upstream side and the drive roller 11 on a downstream side. When the intermediate transfer belt 8 starts to rotate counterclockwise as the drive roller 11 is driven to rotate by a drive motor (not shown), the sheet S is conveyed at prescribed timing from the registration roller pair 13 to the nip (a secondary transfer nip) between the drive roller 11 and the secondary transfer roller 9 provided adjacently to the drive roller 11. Then, a full-color image on the intermediate transfer belt 8 is transferred on the sheet S. The sheet S on which the toner images have been transferred passes through a sheet conveyance path 14 to be conveyed to the fixing device 15.

The sheet S thus conveyed to the fixing device 15 is heated and pressed by a fixing roller pair 15a. This causes the toner images to be fixed on a surface of the sheet S, and thus a prescribed full-color image is formed thereon. In a case of performing printing only on one side of the sheet S, the above-described sheet S is guided to a first conveyance path 19 by a branch portion 18 and is discharged on the discharge tray 22 via a discharge port 21 by a discharge roller pair 20.

On the other hand, in a case of performing printing on both sides of the sheet S, the sheet S that has passed through the fixing device 15 is guided to a second conveyance path 23 by the branch portion 18. Then, a part of the sheet S is made to project once from a switchback roller pair 24 to the intra-body discharge space 30 via an opening 25. After that, the switchback roller pair 24 is caused to rotate reversely, thus effecting switchback of the sheet S, so that the sheet S is guided to a reverse conveyance path 26 and is conveyed, with an image surface thereof reversed, again to the secondary transfer nip via the registration roller pair 13. Then, by the secondary transfer roller 9, a subsequent image formed on the intermediate transfer belt 8 is transferred to a surface of the above-described sheet S on which no image has been formed. Further, the above-described sheet S is conveyed to the fixing device 15 where the toner image is fixed, and then passes through the first conveyance path 19 to be discharged on the discharge tray 22 by the discharge roller pair 20.

It is also possible that a user switches discharging of the sheet S by operating the operation panel 44 (see FIG. 1). For example, a configuration is possible in which the sheet S that has been subjected to normal image formation processing is discharged to the discharge tray 22 through the discharge port 21 by the discharge roller pair 20, while in a case of printing facsimile reception data or the like, the sheet S is discharged through the opening 25 by the switchback roller pair 24 (with no switchback of the sheet S performed). In this case, an auxiliary discharge tray (not shown) is installed over the discharge tray 22, and thus the sheet S discharged from the switchback roller pair 24 can be received by the auxiliary discharge tray so as to be separated from the sheet S discharged on the discharge tray 22 by the discharge roller pair 20.

### [Supplementary Explanation of Sheet Discharge Portion]

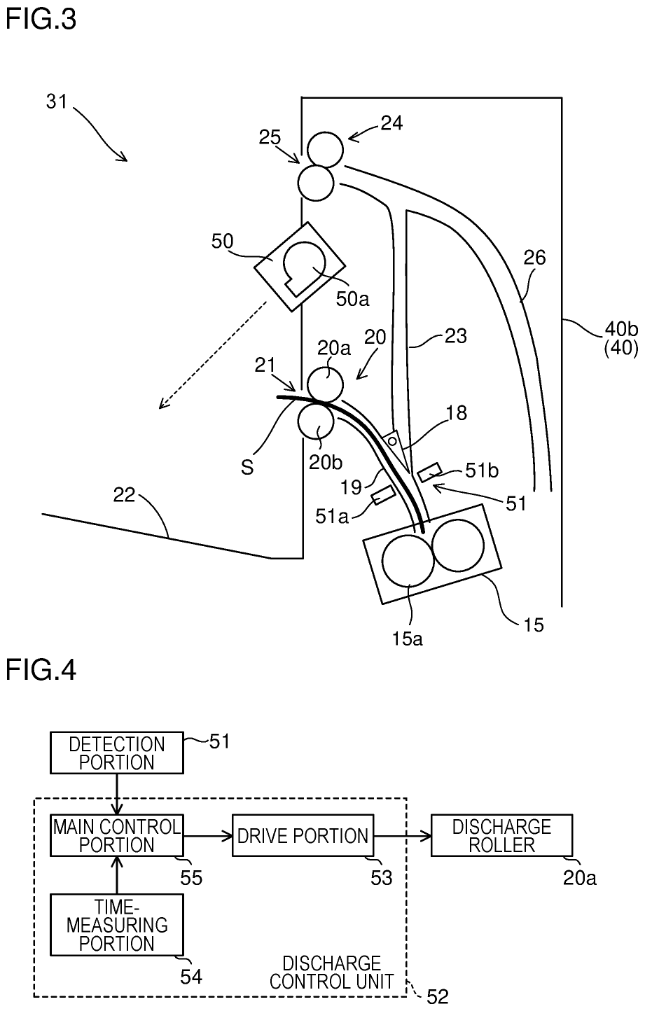

Now, a supplementary explanation is given of the above-described sheet discharge portion 31. FIG. 3 is a sectional view schematically showing a detailed configuration of the sheet discharge portion 31. The sheet discharge portion 31 has the above-described discharge roller pair 20. The discharge roller pair 20 is composed of a discharge roller 20a and a discharge skid 20b that are arranged opposite to each other.

The discharge roller 20a is a drive roller that is driven to rotate by an after-mentioned drive portion 53 (see FIG. 4). The discharge skid 20b is a driven roller that rotates following rotation of the discharge roller 20a. The sheet S is conveyed between the discharge roller 20a and the discharge skid 20b, and in a state where the sheet S is held between these constituting the discharge roller pair 20, the discharge roller 20a is caused to rotate, and thus the sheet S can be discharged on the discharge tray 22 via the discharge port 21. While in this embodiment, relative to the sheet S, the discharge roller 20a is situated on an upper side and the discharge skid 20b is situated on a lower side, a positional relationship between them may be reversed.

Furthermore, the sheet discharge portion 31 has a cooling portion 50. The cooling portion 50 cools the sheet S discharged on the discharge tray 22 by the discharge roller pair 20. In this embodiment, the cooling portion 50 is formed of a cooling fan 50a (for example, a sirocco fan) that cools the sheet S by blowing air thereto. The cooling portion 50 is situated between the discharge port 21 and the opening 25 on a left side surface of the connection housing 40b and is set to blow air obliquely downward. Thus, the sheet S discharged on the discharge tray 22 can be cooled by air blown thereto.

In this embodiment, cooling of the sheet S can be achieved by after-mentioned conveyance control of the sheet S, and thus it is also possible not to install the above-described cooling portion 50.

### [Sheet Discharge Control]

FIG. 4 is a block diagram schematically showing a configuration of a control system that controls rotation of the above-described discharge roller 20a in the image forming apparatus 100 according to this embodiment. The image forming apparatus 100 according to this embodiment further includes a detection portion 51 and a discharge control unit 52.

The detection portion 51 detects the sheet S being conveyed from the fixing device 15 toward the discharge port 21. Here, detecting the sheet S includes detecting a rear end of the sheet S and detecting a front end of the sheet S. The rear end of the sheet S refers to an end of the sheet S on a most upstream side in a conveyance direction of the sheet S being conveyed from the fixing device 15 toward the discharge port 21. Furthermore, the front end of the sheet S refers to an end of the sheet S on a most downstream side in the above-described conveyance direction of the sheet S.

The detection portion 51 is formed of a PI sensor (photo interrupter sensor) having a light-emitting element 51a and a light-receiving element 51b and detects, based on a reception state of light emitted from the light-emitting element 51a and received in the light-receiving element 51b, passage of the front and rear ends of the sheet S therethrough. For example, upon a change in the reception state of light received in the light-receiving element 51b from an ON state where light emitted from the light-emitting element 51a is receivable to an OFF state where the above-described light is not receivable, the detection portion 51 detects that the front end of the sheet S has passed therethrough. Furthermore, thereafter, upon a change in the reception state of light received in the light-receiving element 51b from the OFF state to the ON state, the detection portion 51 detects that the rear end of the sheet S has passed therethrough.

Based on an amount of time that has elapsed from a point in time of detection of the rear end of the sheet S by the detection portion 51, the discharge control unit 52 controls rotation of the discharge roller 20a so as to control a discharge speed of the sheet S. The discharge control unit 52 described as above is configured to have the drive portion 53, a time-measuring portion 54, and a main control portion 55. The drive portion 53 is a drive mechanism for causing the discharge roller 20a to rotate and is configured to include, for example, a motor, a gear, and so on. The time-measuring portion 54 is a timer that measures a time. The main control portion 55 is formed of, for example, a CPU (central processing unit) and controls operations of various portions of the image forming apparatus 100. Particularly, based on a result of detection in the detection portion 51 and an amount of time measured in the time-measuring portion 54, the main control portion 55 controls the drive portion 53.

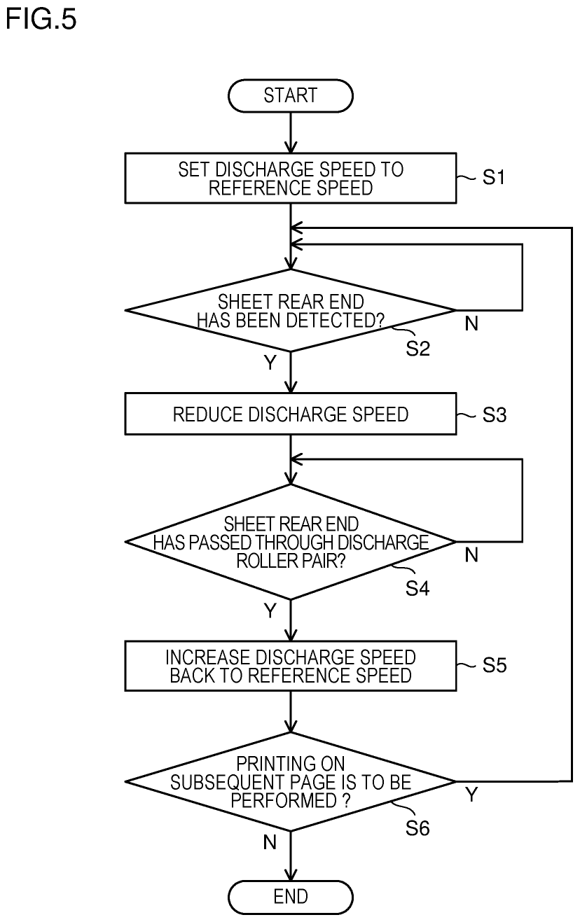

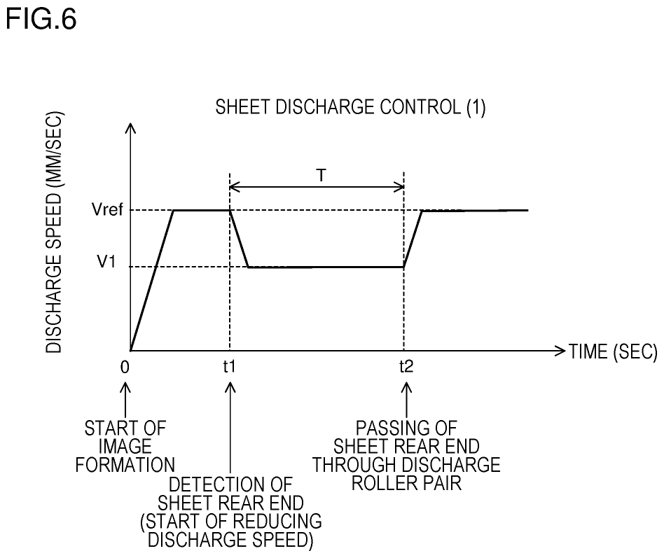

FIG. 5 is a flow chart showing a flow of processing under discharge control of the sheet S according to this embodiment. Furthermore, FIG. 6 is a graph showing variations in discharge speed of the sheet S under the above-described discharge control. The following describes a specific procedure for the discharge control of the sheet S.

First, upon a start of an image forming operation in each of the image forming portions Pa to Pd, the discharge control unit 52 controls rotation of the discharge roller 20a so that the sheet S is discharged at a reference speed Vref (for example, 300 mm/sec) (S1). The above-described reference speed Vref is defined as a speed enabling printing of a desired number of sheets S per prescribed amount of time, namely, a speed enabling desired productivity of the sheet S to be achieved.

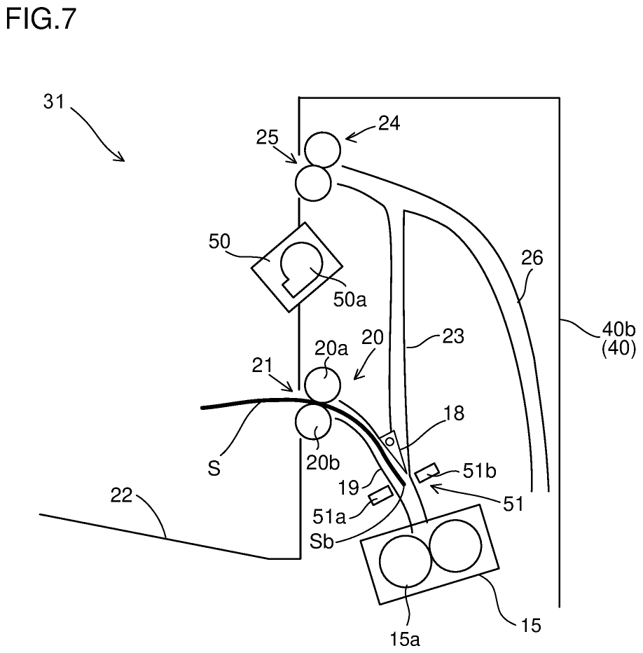

The sheet S on which toner images formed by the image forming portions Pa to Pd have been transferred is conveyed, as described above, to the fixing device 15 where the toner images are fixed and then is discharged from the fixing device 15 (see FIG. 3). Further, upon the detection portion 51 detecting passage of a rear end Sb of the sheet S therethrough as shown in FIG. 7 (S2), the discharge control unit 52 controls rotation of the discharge roller 20a so that the discharge speed of the sheet S is reduced to a speed V1 (for example, 250 mm/sec) lower than the reference speed Vref (S3). A point in time of detection of passage of the rear end Sb of the sheet S by the detection portion 51 is set to a point in time when t1 seconds elapse from a start point in time of image formation.

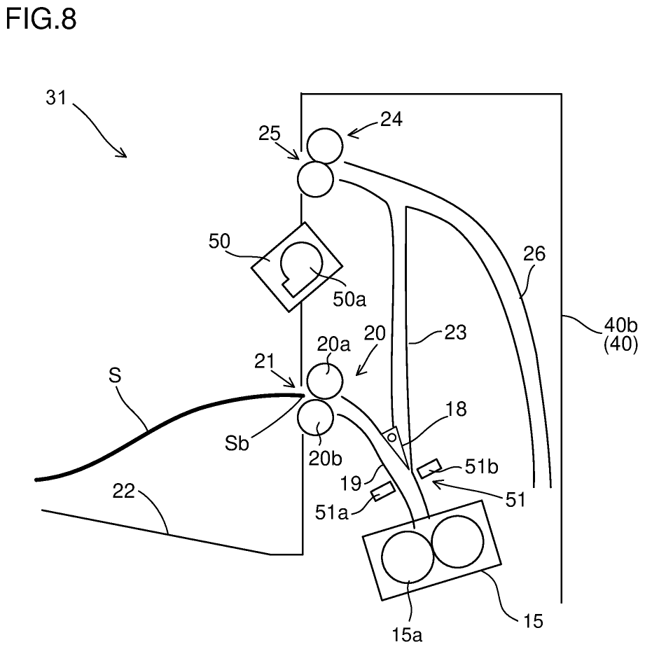

Next, when a prescribed period T has elapsed from the point in time of detection of the rear end Sb of the sheet S by the detection portion 51, the discharge control unit 52 determines that the rear end Sb of the sheet S has passed through the discharge roller pair 20 as shown in FIG. 8 (S4). Upon this determination, the discharge control unit 52 controls rotation of the discharge roller 20a so that the discharge speed of the sheet is increased back to the reference speed Vref (S5).

A conveyance distance of the sheet S from a position at which the rear end Sb of the sheet S is detected by the detection portion 51 to the position of the discharge roller 20a is predetermined in apparatus designing. Accordingly, the discharge control unit 52 can determine the above-described prescribed period T by dividing the above-described conveyance distance of the sheet S by the discharge speed of the sheet S. A scheme may also be adopted in which a conveyance stretch along which the sheet S is conveyed is divided into a plurality of sections, a conveyance distance in each of the plurality of sections is divided by the discharge speed to give an amount of time, and the respective amounts of time thus obtained are summed to determine the above-described prescribed period T. Furthermore, the above-described prescribed period T may be a preset value. This saves the trouble of determining the prescribed period T by calculation. A point in time when the prescribed period T elapses from the point in time of detection of the rear end Sb of the sheet S by the detection portion 51 is set to a point in time when t2 seconds elapse from the start point in time of image formation.

The discharge control unit 52 determines whether or not continuous printing has been designated via the operation panel 44 (see FIG. 1) (S6). In a case where continuous printing has been designated, a return is made to S2 so that discharge control steps similar to the above are repeatedly performed, and in a case where continuous printing has not been designated, the discharge control of the sheet S is ended.

While the foregoing has described an example in which at the point in time of detection of passage of the rear end Sb of the sheet S by the detection portion 51 (after a lapse of t1 seconds from the start point in time of image formation), the discharge control unit 52 performs control so that the discharge speed of the sheet S is reduced to the speed V1 (see S2 and S3), timing for reducing the discharge speed is not limited to the point in time of detection of passage of the rear end Sb of the sheet S.

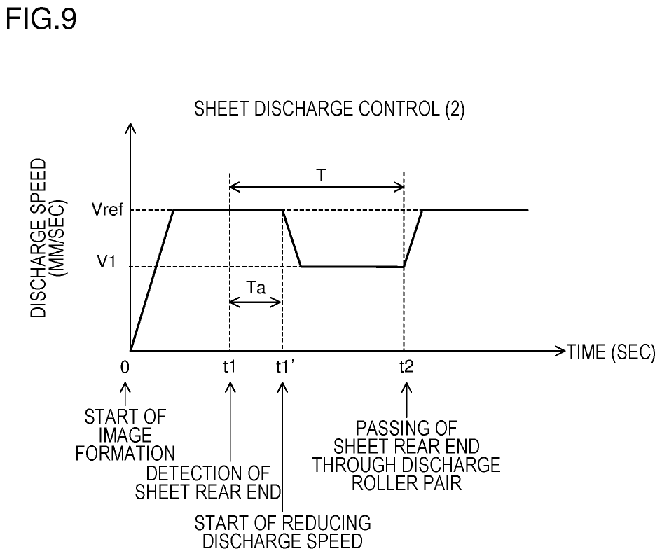

FIG. 9 is a graph showing variations in discharge speed under another type of discharge control of the sheet S. As shown in the figure, the discharge control unit 52 may perform control so that after a further lapse of Ta seconds from the point in time of detection of passage of the rear end Sb of the sheet S by the detection portion 51 (after a lapse of t1′ (>t1) seconds from the start point in time of image formation), the discharge speed of the sheet S is reduced from the reference speed Vref. That is, the discharge speed of the sheet S may be reduced at any timing as long as the timing falls within the prescribed period T including the point in time of detection of the rear end Sb of the sheet S (the above-described prescribed period T, however, does not include a point in time when the rear end Sb of the sheet S passes through the discharge roller pair 209).

As discussed above, in this embodiment, the discharge control unit 52 performs control so that within the prescribed period T from the point in time of detection of the rear end Sb of the sheet S by the detection portion 51 to when the rear end Sb of the sheet S passes through the discharge roller pair 20, the discharge speed of the sheet S is reduced to a value lower than the reference speed Vref. This suppresses a phenomenon in which when discharged by the discharge roller pair 20, the sheet S is caused by the discharge roller pair 20 to fly out vigorously as in a case of being discharged at the reference speed Vref, which is high. Accordingly, even in, for example, continuous printing, the sheets S can be stacked on the discharge tray 22 so that an excellent alignment property is achieved, and thus the alignment property (stacking property) of the sheets S being discharged can be improved.

Furthermore, the discharge speed of the sheet S is reduced to a value lower than the reference speed Vref, and thus it is possible to gain more time for the sheet S to be conveyed from the fixing device 15 to the discharge port 21. Thus, even in a case of a shorter conveyance distance of the sheet S from the fixing device 15 to the discharge port 21, the above-described increased conveyance time makes it possible for the sheet S to be cooled naturally while being conveyed (in a conveyance path). The sheet S that has been cooled naturally in this manner is discharged on the discharge tray 22, so that it is possible to reduce occurrence of re-fusion of toner on the discharged sheet S, thus suppressing sticking between the sheets S on the discharge tray 22. Furthermore, increasing the conveyance time of the sheet S as described above makes it possible for the sheet S to be cooled naturally, and thus it is also possible not to install the cooling portion 50 for intentionally cooling the sheet S. This can reduce a cost required to install the cooling portion 50.

Furthermore, after a lapse of the prescribed period T, that is, after the rear end Sb of the sheet S has passed through the discharge roller pair 20, the discharge speed of the sheet S is increased back to the reference speed Vref as an original value. Thus, even in, for example, continuous printing, a subsequent sheet S can be conveyed swiftly (until the discharge speed is reduced based on detection of the rear end). This makes it possible to avoid a decrease in the number of sheets printed per prescribed amount of time, thus maintaining productivity of the sheet S.

That is, according to the configuration of this embodiment, it is possible, while maintaining productivity of the sheet S, to obtain the above-described effects of improving the alignment property of the sheets S on the discharge tray 22 and of suppressing sticking between the sheets S.

Furthermore, for example, in a configuration in which control of the discharge speed of the sheet S is triggered by detection of the front end of the sheet S, depending on the position at which the detection portion 51 is arranged, a part of the sheet S may lie inside the fixing device 15 at a point in time of detection of the front end of the sheet S. Reducing the discharge speed in this state leads to a fear that variations might occur in a fixing time in the fixing device 15, causing degradation in image quality. In contrast, in a configuration in which, as in this embodiment, control of the discharge speed of the sheet S is triggered by detection of the rear end of the sheet S, it is possible to control the discharge speed of the sheet S that has been discharged completely from the fixing device 15, thus eliminating the need to be concerned about degradation in image quality due to variations in the fixing time.

Furthermore, in this embodiment, as shown in FIG. 6, the discharge control unit 52 performs control so that at the point in time of detection of the rear end Sb of the sheet S, the discharge speed of the sheet S is reduced to a value lower than the reference speed Vref. Thus, it is possible to maximally increase a conveyance time of the sheet S for a set conveyance distance of the sheet S between the fixing device 15 and the discharge port 21. Accordingly, it is possible to maximally increase an amount of time in which the sheet S is cooled naturally by being conveyed, and thus it is possible, while maintaining productivity of the sheet S, to enhance an effect of suppressing sticking between the sheets S on the discharge tray 22.

On the other hand, when, as shown in FIG. 9, the discharge control unit 52 performs control so that at timing later than the point in time of detection of the rear end Sb of the sheet S, the discharge speed of the sheet S is reduced to a value lower than the reference speed Vref, an amount of time in which the sheet S can be cooled naturally is decreased compared with the control shown in FIG. 6. Until a point t1′ in time when the discharge speed of the sheet S is reduced, however, the sheet S can be conveyed swiftly at the reference speed Vref. Thus, it is possible to improve productivity of the sheet S in continuous printing.

Furthermore, the above-described prescribed period T is a duration determined based on a predetermined conveyance distance of the sheet S from a position at which the rear end Sb of the sheet S is detected by the detection portion 51 to the position of the discharge roller pair 20 and the discharge speed of the sheet S. The prescribed period T is thus determined based on the conveyance distance and discharge speed of the sheet S, and thus it is possible to reliably perform the control according to this embodiment in which, within the prescribed period T from the point in time of detection of the rear end Sb of the sheet S, the conveyance speed of sheet S is reduced from the reference speed Vref, and after a lapse of the prescribed period T, the conveyance speed of the sheet S is increased back to the reference speed Vref as an original value.

Furthermore, the image forming apparatus 100 according to this embodiment includes the cooling portion 50. The sheet S, therefore, is not only cooled naturally under the above-described discharge control (by reducing the discharge speed of the sheet S) according to this embodiment but also cooled by the cooling portion 50, and thus it is possible to reliably reduce occurrence of re-fusion of toner on the discharge tray 22. This makes it possible to reliably suppress sticking between the sheets on the discharge tray 22.

Particularly, in a case where the cooling portion 50 is formed of the fan 50a, the sheet S can be easily cooled by air blown by the fan 50a, and thus it is possible to easily obtain the effect of suppressing sticking between the sheets S on the discharge tray 22.

While this embodiment has described a case of controlling discharging of the sheet S in a color copy machine, the discharge control of the sheet S according to this embodiment is applicable to various types of image forming apparatuses such as a monochrome copy machine, a monochrome printer, a color printer, a facsimile, and a multi-functional peripheral.

### INDUSTRIAL APPLICABILITY

The present invention is usable in an image forming apparatus such as a color copy machine.

1. An image forming apparatus, comprising:
a fixing device that fixes a toner image on a sheet;
a discharge roller pair that discharges the sheet on which the toner image has been fixed in the fixing device to a discharge tray via a discharge port;
a detection portion that detects a rear end of the sheet being conveyed from the fixing device toward the discharge port; and
a discharge control unit that, based on an amount of time that has elapsed from a point in time of detection of the rear end of the sheet by the detection portion, controls rotation of a discharge roller included in the discharge roller pair so as to control a discharge speed of the sheet,
wherein
the discharge control unit performs control so that, within a prescribed period from the point in time of detection of the rear end to when the rear end of the sheet passes through the discharge roller pair, the discharge speed of the sheet is reduced to a value lower than a reference speed, and after a lapse of the prescribed period, the discharge speed of the sheet is increased back to the reference speed.

2. The image forming apparatus according to claim 1, wherein
the discharge control unit performs control so that at the point in time of detection of the rear end, the discharge speed of the sheet is reduced to a value lower than the reference speed.

3. The image forming apparatus according to claim 1, wherein
the discharge control unit performs control so that at timing later than the point in time of detection of the rear end, the discharge speed of the sheet is reduced to a value lower than the reference speed.

4. The image forming apparatus according to claim 1, wherein
the prescribed period is a duration determined based on a predetermined conveyance distance of the sheet from a position at which the rear end of the sheet is detected by the detection portion to a position of the discharge roller pair and the discharge speed of the sheet.

5. The image forming apparatus according to claim 1, further comprising:
a cooling portion that cools the sheet discharged on the discharge tray by the discharge roller pair.

6. The image forming apparatus according to claim 5, wherein
the cooling portion is formed of a fan that cools the sheet by blowing air to the sheet.
